(19) United States
(12) Patent Application Publication
(10) Pub. No.: US 2026/0163126 A1
(43) Pub. Date: Jun. 11, 2026

(54) SECONDARY BATTERY AND METHOD OF MANUFACTURING THE SECONDARY BATTERY

(71) Applicant: SAMSUNG SDI CO., LTD., Yongin-si (KR)

(72) Inventor: Dong Bok YANG, Yongin-si (KR)

(21) Appl. No.: 19/333,696

(22) Filed: Sep. 19, 2025

(30) Foreign Application Priority Data
Dec. 5, 2024 (KR) 10-2024-0179129

(51) Int. Cl. H01M 50/105; H01M 10/04; H01M 50/119; H01M 50/186; H01M 50/193; H01M 50/197

(52) U.S. Cl. CPC H01M 50/105; H01M 10/0468; H01M 50/119; H01M 50/186; H01M 50/193; H01M 50/197

(57) ABSTRACT

The present disclosure provides a secondary battery. The secondary battery can include an electrode assembly having a first electrode, a separating film, and a second electrode, a case in which the electrode assembly is accommodated, the case having an open surface and an inner surface having at least one notch, a cover coupled to the open surface of the case, and at least one adhesive member interposed between the electrode assembly and the case, the adhesive member is placed in the at least one notch groove.

### CROSS-REFERENCE TO RELATED APPLICATION

This application claims priority under 35 U.S.C. § 119 to Korean Patent Application No. 10-2024-0179129, filed in the Korean Intellectual Property Office on Dec. 5, 2024, the entire contents of which are hereby incorporated by reference.

### BACKGROUND

### Field

The present disclosure relates to a secondary battery and a method of manufacturing the secondary battery.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

With the announcement from the European Union (EU) of regulations that require mobile phones to use detachable batteries, the development of Stainless Steel (SUS) cells is accelerated. Conventional pouch batteries, which have been widely used, have the drawback of being easily damaged during detachment due to flexible casing material forming the pouch.

As the range of applications for secondary batteries in mobile devices expands, dropping devices equipped with secondary batteries occurs more frequently. When devices with secondary batteries are dropped, the battery mounted in the device may be damaged from the impact, which potentially causes short circuit, smoke, or fire. For example, during a fall, the electrode assembly inside the case may move excessively, which increases the risk of short circuits due to collisions within the case of the mobile device.

The above information disclosed in this Background section is for enhancement of understanding of the background of the present disclosure, and therefore, it may contain information that does not constitute related (or prior) art.

### SUMMARY

The present disclosure is aimed to provide a secondary battery and a method for manufacturing the secondary battery to solve the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

Aspects of embodiments provide a secondary battery including an electrode assembly comprising a first electrode, a separating film, and a second electrode, a case in which the electrode assembly is accommodated, the case including an open surface and an inner surface having at least one notch groove, a cover coupled to the open surface of the case, and at least one adhesive member interposed between the electrode assembly and the case, wherein the adhesive member is placed in the at least one notch groove.

According to one embodiment, the adhesive member may be inserted into the at least one notch groove by being pressed between the electrode assembly and the case. In another embodiment, the adhesive member can be further pressed into the at least one notch groove when the electrode assembly and the case are pressurized (removing any internal gas that occurs during initial charging and discharging processes).

According to one embodiment, a cross-sectional shape of the notch groove may be one of a triangle, a rectangle, a trapezoid, or an arc.

According to one embodiment, the at least one notch groove may comprise at least one of a plurality of linear notch grooves extending in a first direction or a plurality of intersecting linear notch grooves extending in both the first direction and a second direction intersecting the first direction, wherein the plurality of notch grooves are separated from each other by a predetermined distance.

According to one embodiment, the at least one notch groove may be formed in a patterned shape by repeating rectangles or circles.

According to one embodiment, a front shape of the at least one notch groove may be a multi-dots shape, a multi-curves shape, or a multi-straight lines shape.

According to one embodiment, a depth of the at least one notch groove may be between 5% and 10% (inclusive) of a thickness of the case.

According to one embodiment, the secondary battery may further include a compression member interposed between the electrode assembly and the cover, wherein the cover comprises the at least one notch groove formed on an inner surface where the compression member is arranged.

According to one embodiment, the adhesive member may include an adhesive layer adhered to the electrode assembly via a first surface of the adhesive layer, and a film layer on a second surface of the adhesive layer, the film layer contacting the at least one notch groove.

According to one embodiment, the adhesive layer may include at least one of hot melt, rubber, or acrylic, wherein the film layer includes at least one of Oriented Polystyrene (OPS), Cast Polypropylene (CPP), Polyethylene terephthalate (PET), Polyethylene (PE), or High Impact Polystyrene (HIPS).

According to one embodiment, one of the case or the cover may include stainless steel (SUS).

Aspects of embodiments provide a method for manufacturing a secondary battery, the method including arranging an adhesive member in a case where a notch groove is formed on an inner surface of the case, inserting an electrode assembly into an open surface of the case, bonding the cover onto the open surface of the case, and combining the case and the cover together by a press jig.

According to one embodiment, the adhesive member may be pressed between the electrode assembly and the case such that the adhesive member is inserted into the notch groove.

According to one embodiment, a cross-sectional shape of the notch groove may be one of a triangle, a rectangle, a trapezoid, or an arc.

According to one embodiment, the notch groove may include a plurality of linear notch grooves extending in a first direction or a plurality of intersecting linear notch grooves extending in both the first direction and a second direction intersecting the first direction, wherein the plurality of linear notch grooves or the plurality of intersecting linear notch grooves are separated from each other by a predetermined distance.

According to one embodiment, the notch groove may be formed in a patterned shape by repeating a rectangle or a circle.

According to one embodiment, a shape of the notch groove may be a multiple-dots shape, a multiple-curves shape, or a multiple-straight lines shape.

According to one embodiment, a depth of the notch groove may be between 5% and 10% (inclusive) of a thickness of the case.

According to one embodiment, the method may further include inserting a compression member between the electrode assembly and the cover, wherein the cover comprises the notch groove formed on the inner surface where the compression member is arranged.

According to one embodiment, the adhesive member may include an adhesive layer adhered to the electrode assembly via a first surface of the adhesive layer, and a film layer on a second surface of the adhesive layer, the film layer contacting the notch groove.

According to an embodiment, an adhesive member may be placed between an electrode assembly and a case, with the adhesive member inserted into a notch groove to maximize the contact area. Thus, the adhesion between the electrode assembly and the case may be increased, mitigating the likelihood that the electrode assembly will detach during a fall.

According to embodiments of the present disclosure, uniform adhesion may be provided between the electrode assembly and the case by combining the cross-sectional shape and the front surface of the notch groove(s) in various ways. Accordingly, the deformations due to detachments of the electrode assembly caused by dropping the secondary battery, and subsequent ignition accidents caused by short-circuits resulting from those deformations, may be prevented, thereby enhancing the safety of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view illustrating an example of a secondary battery;

FIG. 2 is a perspective view illustrating an example of a secondary battery;

FIG. 3 is a cross-sectional view illustrating an example of a secondary battery according to embodiments of the present disclosure′

FIG. 4 is a cross-sectional view illustrating a secondary battery to which a compressing member is added in FIG. 3;

FIG. 5 is a cross-sectional view illustrating an example where the cross-section of a notch groove is a triangle shape;

FIG. 6 is a cross-sectional view illustrating an example where the cross-section of a notch groove is an arc shape′

FIG. 7 is a cross-sectional view illustrating an example where the cross-section of a notch groove is a rectangular shape;

FIG. 8 is a cross-sectional view illustrating an example where the cross-section of a notch groove is a trapezoid shape;

FIG. 9 is a cross-sectional view illustrating an example where the cross-section of a notch groove is an inclined triangle shape;

FIG. 10 is a view illustrating an example where a front shape of the notch groove is linearly formed;

FIG. 11 is a view illustrating an example where a front shape of the notch groove is linearly formed;

FIG. 12 is a cross-sectional view illustrating notch grooves in FIG. 10 and FIG. 11 are combined;

FIG. 13 is a view illustrating an example where a front shape of a notch groove forms a pattern/shape;

FIG. 14 is a view illustrating another example where a front shape of a notch groove forms a pattern/shape;

FIG. 15 is a view illustrating yet another example where a front shape of a notch groove forms a pattern/shape;

FIG. 16 is a view illustrating that a front shape of the notch groove is shaped in a multiple dots shape;

FIG. 17 is a view illustrating an example where the front of the notch groove is formed by combining a plurality of lines;

FIG. 18 is a view illustrating an example of the depth of the notch groove according to embodiments of the present disclosure;

FIG. 19 is a view illustrating an example of a stacked structure of an adhesive member;

FIG. 20 is a view illustrating an example of an adhesive member stacked in two layers;

FIG. 21 is an exemplary schematic view illustrating a battery electronic device;

FIG. 22 illustrates an example of a secondary battery according to embodiments of the present disclosure placed in the battery electronic device of FIG. 21;

FIG. 23 is a flowchart illustrating an example of a manufacturing method of a secondary battery according to embodiments of the present disclosure;

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

As disclosed herein, singular expressions include plural expressions unless the context clearly specifies singular expressions. In addition, plural expressions include singular expressions unless the context clearly specifies plural expressions. Likewise, when a part is described as including a component, it implies that additional components may also be included unless specifically stated to the contrary.

According to embodiments of the present disclosure, the sizes of layers and areas are illustrated in the drawings may be exaggerated for clarity of explanation. The sizes in the drawings are only for ease of explanation, but the present disclosure is not limited thereto. Reference numerals in the drawings denote like elements throughout this disclosure.

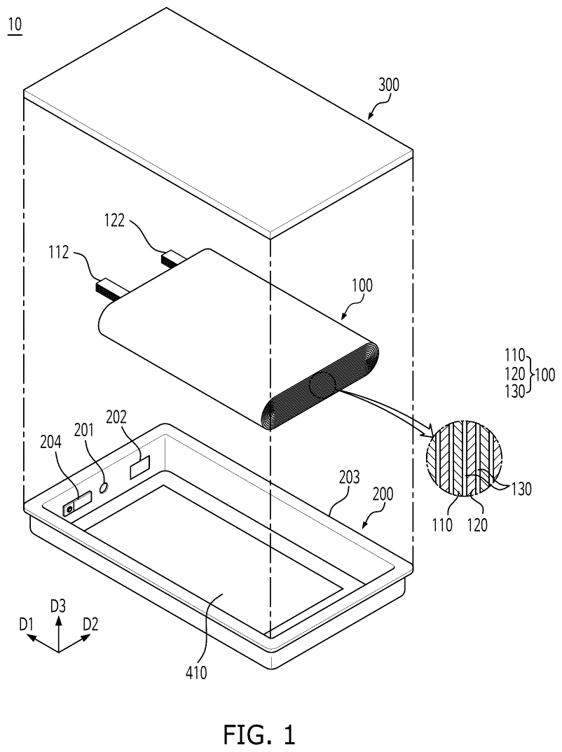

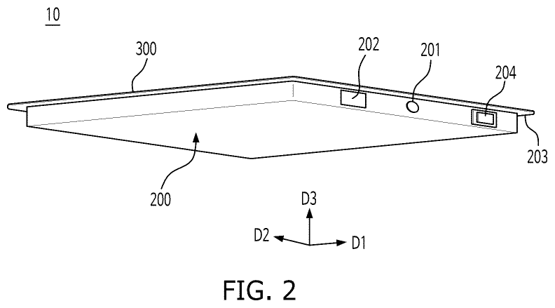

FIG. 1 is an exploded perspective view illustrating an example of a secondary battery, and FIG. 2 is a perspective view illustrating an example of a secondary battery.

Referring to FIG. 1 and FIG. 2, a secondary battery 10 may include an electrode assembly 100, a case 200 including an accommodating space in which the electrode assembly 100 is accommodated, a cover 300 coupled to the case 200, and an adhesive member 410 interposed between the electrode assembly 100 and the case 200.

The electrode assembly 100 may include a first electrode 110, a separating film 130, and a second electrode 120. For example, the electrode assembly 100 may be wound or stacked with the separating film 130, which is an insulator, between the first electrode 110 and the second electrode 120. The first electrode 110 may include a first substrate, and a first active material layer placed on the first substrate. A first electrode tab 112 may outwardly extend in a non-coated portion of the first substrate (i.e., where the first active material layer has not been applied). The second electrode 120 may include a second substrate, and a second active material layer disposed on a second substrate. A second electrode tab 122 may outwardly extend in a second non-coated portion of the second substrate (i.e., where the second active material has not been applied).

The first electrode 110 may function as a positive electrode. In this case, the first substrate may be a positive electrode substrate. The positive electrode substrate may be formed of aluminum foil, and a positive electrode active material may include, for example, a transition metal oxide.

The positive electrode active material may include a compound (e.g., a lithiated intercalation compound) that is capable of intercalating and deintercalating lithium. Specifically, the positive electrode active material may be at least one of a composite oxide of lithium and a metal selected from cobalt, manganese, nickel, and/or combinations thereof.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, and/or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO 2(0.90≤a≤1.8, 0≤b≤0.9, 0≤c≤0.5, 0≤d≤0.5, and 0≤e≤0.1); LiaNiGbO2(0.90≤a≤1.8 and 0.001≤b≤0.1); LiaCoGbO2(0.90≤a≤1.8 and 0.001≤b≤0.1); LiaMn1-bGbO2 (0.90≤a≤1.8 and 0.001≤b≤0.1); LiaMn2GbO4(0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 120 may function as a negative electrode. In this case, the second substrate may be a negative electrode substrate. The negative electrode substrate may be made of, for example, copper foil and/or nickel foil, and a negative electrode active material may include, for example, graphite.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example. crystalline carbon, amorphous carbon and/or a combination thereof. The crystalline carbon may be graphite such as non-shaped, sheet-shaped, flake-shaped, sphere-shaped, or fiber-shaped natural graphite and/or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material and/or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and/or a combination thereof). The Sn-based negative electrode active material may include Sn, SnO2, a Sn-based alloy, and/or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material. The separator 130 may include polyethylene, polypropylene, polyvinylidene fluoride, and/or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, and/or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, and polytetrafluoroethylene, or a copolymer or mixture of two or more thereof.

The organic material may include a polyvinylidene fluoride-based polymer and/or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3, Mg(OH)2, boehmite, and/or a combination thereof, but is not limited thereto.

The organic material and the inorganic material may be mixed in one coating layer, or a coating layer including an organic material and a coating layer including an inorganic material may be stacked.

The case 200 may have a surface (e.g., the surface of the case 200 in a D3 direction) open to accommodate the electrode assembly 100. That is, one end of the case 200 may be open, and an accommodating space for accommodating the electrode assembly 100 may be formed. The electrode assembly 100 may then be inserted into the open end of the case 200 to be accommodated in the accommodating space. The cover 300 may then be coupled to the open one surface of the case 200 to seal the accommodating space.

According to embodiments, the case 200 may include a negative electrode terminal 202 and a positive electrode terminal 204 placed on a side surface (e.g., a surface of the case 200 in a D1 direction) different from the open surface. The case 200 may include an electrolyte injection port 201. For example, the electrolyte injection port 201 may be a hole formed on a side surface of the case 200. The electrolyte injection port 201 may be formed to inject an electrolyte into the inside of the case 200 of the secondary battery 10 after the case 200 and the cover 300 are bonded and sealed. The electrolyte injection port 201 may be sealed by a sealing member after the electrolyte is injected. According to embodiments of the present disclosure, the electrolyte injection port 201 is illustrated to be positioned between a pair of electrode terminals, but the present disclosure is not limited thereto, but may have various modifications.

In some configurations, the locations of the electrode terminals can vary. For example, rather than having the pair of electrode terminals 202, 204 located as illustrated in FIG. 1, the pair of electrode terminals 202, 204 may be placed on the side surface of the case 200. For example, the negative electrode terminal 202 and the positive electrode terminal 204 may be placed on both sides in a D2 direction with respect to the electrolyte injection port 201.

The positive electrode terminal 204 may be electrically connected to a first electrode tab 112 of the electrode assembly 100, and a negative electrode terminal 202 may be electrically connected to the second electrode tab 122 of the electrode assembly 100. The positions of the positive electrode terminal 204 and the negative electrode terminal 202 according to the present disclosure is not limited to the positions illustrated in FIG. 1, and may have various modifications.

According to embodiments, an accommodating space for accommodating the electrode assembly 100 in the case 200 may be formed near a center area of the case 200 by a pressing, bending, folding, etc. For example, a flange 203 may be formed in all directions at the edge of the top of the accommodating space.

The cover 300 may be coupled to the open surface of the case 200. According to embodiments, the case 200 and the cover 300 may be bonded to each other to form an exterior of the secondary battery 10. For example, the cover 300 may be shaped as a flat plate, and may be disposed on the top of the case 200 to seal the accommodating space of the case 200. The cover 300 may have a size and shape which covers the flange 203, resulting in surface contact with the flange 203. The thickness of the case 200 and the cover 300 may range from 0.05 mm to 0.3 mm, but the present disclosure is not limited thereto.

The case 200 and the cover 300 may be bonded/coupled together through metal-bonding (e.g., a welding, a brazing, a soldering, etc.) In this case, the edge of the flange 203 and the cover 300 of the case 200 may be bonded. After the case 200 and the cover 300 are bonded, at least part of the flange 203 may be cut by laser for improving the energy density of the secondary battery 10.

According to some embodiments, at least one of the case 200 and the cover 300 may include stainless steel (SUS). For example, the case 200 and the cover 300 illustrated in FIG. 1 may include stainless steel (SUS), and the secondary battery 10 may be a SUS can-type secondary battery, but is not limited thereto. For example, the case 200 and the cover 300 may be formed of a conductive metal such as aluminum, an aluminum alloy, and/or nickel-plated steel, to form the entire exterior of the secondary battery 10.

The case 200 and the cover 300 may be formed of the same metallic material. Corrosion along the bond due to a potential difference between different metals in the case 200 and the cover 300 by forming composing the case 200 and the cover 300 from the same material. According to some embodiments, the metallic material constituting the case 200 and the cover 300 may include stainless steel (SUS). The stainless steel material may be any type of stainless steel material such as SUS 304, SUS 316, SUS 420, or SUS 430, depending on the types and ratios of the alloy materials in the stainless steel series.

The secondary battery 10 may be a lithium battery cell, a sodium battery cell, etc. However, the scope of the present disclosure is not limited thereto—the secondary battery 10 may include any type of battery that repeatedly provides electricity by charging and discharging.

The components of the secondary battery illustrated in FIG. 1 are merely exemplary, and may include or exclude other components according to some embodiments. For example, the shape or positional relationship, etc., of each component of the secondary battery illustrated in FIG. 1 may be appropriately changed.

D1, D2, and D3 illustrated in FIG. 1 may respectively indicate the length direction, the width direction, and the thickness direction of the secondary battery 10 or the components of the secondary battery 10 (e.g., the case 100, the electrode assembly 130, etc.).

According to some embodiments, at least one adhesive member 410 may be disposed between the electrode assembly 100 and the case 200. The adhesive member 410 may be disposed in the accommodating spaced formed by the case 200. For example, the adhesive member 410 may be placed on the outer surface of the electrode assembly 100 or on the inner surface of the case 200 corresponding to the electrode assembly 100. Once the adhesive member 410 adheres to both the inner surface of case 200 and the outer surface of the electrode assembly 100, the adhesive member 410 may hold the electrode assembly 110 in place within the case 200.

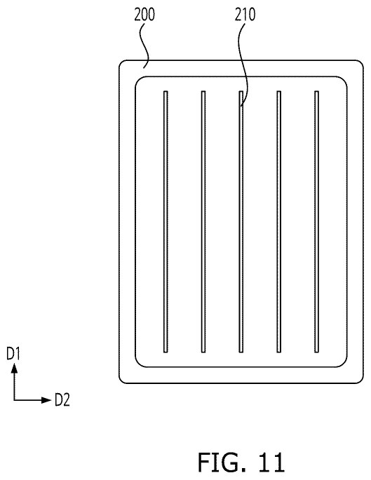

For example, the adhesive member 410 may be coupled to a portion of the inner surface of the case 200. As another example, the adhesive member 410 may be coupled to the outer surface of the electrode assembly 100 facing the inner surface of the case 200. FIG. 11 illustrates a non-limiting example of the adhesive member 410 coupled to a portion of the inner surface of the case 200. In another example, the adhesive member 410 may be coupled to the entire outer surface, or at least part of the outer surface, of the electrode assembly 100. For example, the adhesive member 410 may be coupled to the entire inner surface of the case 200.

In FIG. 1, the adhesive member 410 is illustrated as having a square shape, but it is not limited thereto. For example, the adhesive member 410 may have a polygonal, circular, oval shape, etc.

For example, the length of the adhesive member 410 in the D1 direction and D2 direction may be the same as the length of the electrode assembly 100 in the D1 direction and D2 direction. The contacting area between the electrode assembly 100 and the adhesive member 410 may be maximized, and an adhesive force may be improved. Therefore, the issue of detachment of the electrode assembly 100 during a drop impact of the secondary battery 10 may be mitigated.

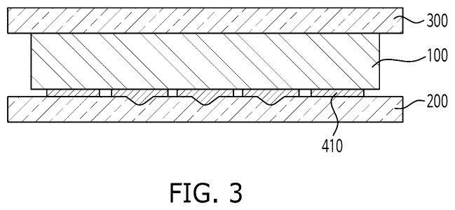

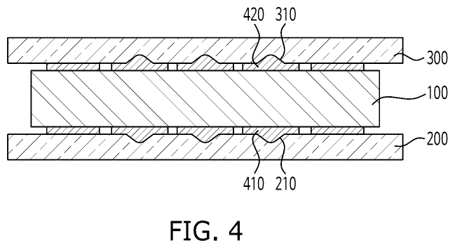

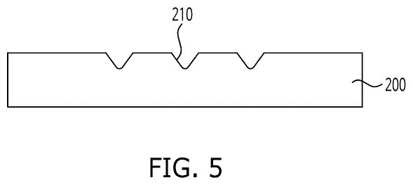

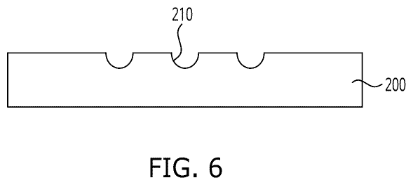

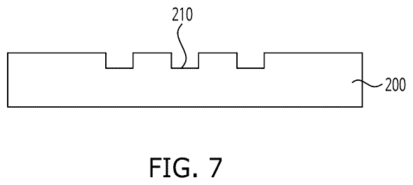

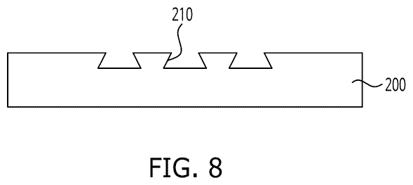

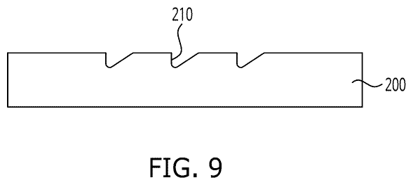

FIG. 3 is a cross-sectional view illustrating an example of a secondary battery according to embodiments of the present disclosure. FIG. 4 is a cross-sectional view illustrating a secondary battery to which a compressing member is added in FIG. 3. FIG. 5 is a cross-sectional view illustrating an example where the cross-section of a notch groove is a triangle shape. FIG. 6 is a cross-sectional view illustrating an example where the cross-section of a notch groove is an arc shape. FIG. 7 is a cross-sectional view illustrating an example where the cross-section of a notch groove is a rectangular shape. FIG. 8 is a cross-sectional view illustrating an example where the cross-section of a notch groove is a trapezoid shape. FIG. 9 is a cross-sectional view illustrating an example where the cross-section of a notch groove is an inclined triangle shape.

The case 200 may include at least one notch groove 210 formed on the inner surface in which an adhesive member 410 is placed. The notch groove(s) 210 may be embodied as a plurality of recessed portions spaced apart from each other. The shape of the notch groove 210 may vary, and the distance between the notch grooves 210 may likewise vary.

The adhesive member 410 may be pressed between the electrode assembly 100 and the case 200 and inserted into the notch groove 210. The notch groove 210 may be notched from the inner surface towards the outer surface of the case 200. For example, the notch groove 210 may be notched in the direction from the inner surface adjacent to the electrode assembly 100 toward the outer surface of the case 200.

The secondary battery may be formed by pressurizing the case 200 and the cover 300 (removing any internal gas that occurs during initial charging and discharging processes), causing the adhesive member 410 to be further pressed into the inner wall of the case 200 and inserted into the notch groove 210. Thus, the contact area between the adhesive member 410 and the case 200 may be maximized and the adhesive force between the electrode assembly 100 and the case 200 may be improved. As stated above, this can mitigate the detachment of the electrode assembly 100 during a drop impact of the secondary battery 10.

The secondary battery may further include a compression member 420 interposed between the electrode assembly 100 and the cover 300. The cover 300 may include at least one notch groove 310 formed in the inner surface where the compression member 420 is placed. The notch groove(s) 310 formed in the cover 300 may have the same function and shape as the notch groove(s) 210 formed in the case 200.

The compression member 420 may be pressed between the electrode assembly 100 and the cover 300 and inserted into the notch groove 310. The secondary battery may be formed by pressurizing the case 200 (removing any internal gas that occurs during initial charging and discharging processes) and the cover 300 together, and the compression member 420 may be further compressed into the inner wall of the cover 300 and inserted into the notch groove 310. Therefore, the contact area between the adhesive member 410 and the cover 300 may be maximized, and the adhesive force between the electrode assembly 100 and the cover 300 may be improved. Whereas the adhesive member 410 prevents the electrode assembly 100 from detaching from the case 200, the compression member 420 prevents movement of the electrode assembly 100 towards the cover 300. Thus, the issue of movement of the electrode assembly 100 during a drop impact of the secondary battery 10 may be mitigated.

For example, the adhesive member 410 may be interposed between the electrode assembly 100 and the case 200. The adhesive member 410 may be interposed between the electrode assembly 100 and the case accommodated in the internal space of the case 200. In other embodiments, the compression member 420 may be interposed between the electrode assembly 100 and the cover 300. The adhesive member 420 may be interposed between the electrode assembly 100 and the cover 300 accommodated in the inner space of the case 200.

The cross-sectional shape of the notch groove 210 may be a triangle, square, trapezoid, or arc. However, the present disclosure is not limited thereto, and the notch groove 210 may be implemented in various shapes such as an oval or other shapes as needed, and the shape of each of a plurality of notch grooves 210 may also be formed differently (e.g., there may be notch grooves in the same of an oval and a triangle (or other shapes) within a single case 200 or cover 300).

The cross-sectional shape of the notch groove 210 may not be limited so long as the notch groove 210 effectively prevents detachment and/or movement of the electrode assembly 100. For example, as shown in FIG. 9, when the shape of the cross-section of the notch groove 210 is an inclined triangle, left and right flows of the electrode assembly may be effectively prevented.

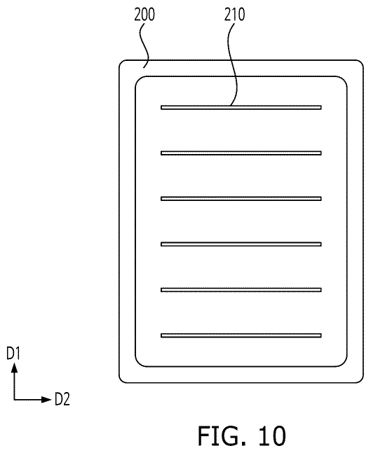

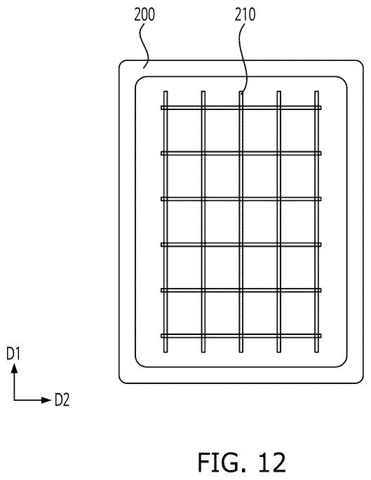

FIG. 10 is a view illustrating an example where a front shape of the notch groove is linearly formed, FIG. 11 is a view illustrating an example where a front shape of the notch groove is linearly formed, and FIG. 12 is a cross-sectional view illustrating notch grooves in FIG. 10 and FIG. 11 are combined.

Referring to FIG. 10 to FIG. 12, a notch groove 210 may be formed in a linear shape (i.e., linear notch grooves) extending in a first direction D1 of the case 200, and/or a second direction D2 intersecting the first direction D1. For example, the notch groove 210 may include a plurality of notch grooves arranged in the first direction D1 (as illustrated in FIG. 11) or the second direction D2 (as illustrated in FIG. 10). The plurality of notch grooves 210 may be spaced apart (i.e., separated) from each other by a predetermined distance in in the first direction D1 or the second direction D2.

The plurality of notch grooves 210 may be combined in a linear shape, thereby effectively preventing the flows in all directions of the electrode assembly 100. The notch groove 210 may be placed at a plurality of points on the inner plane of the case 200, so that the electrode assembly may be uniformly seated in the case 200.

The space where the plurality of notch groove 210 are spaced apart may vary, and the number of notch groove 210 may not be limited.

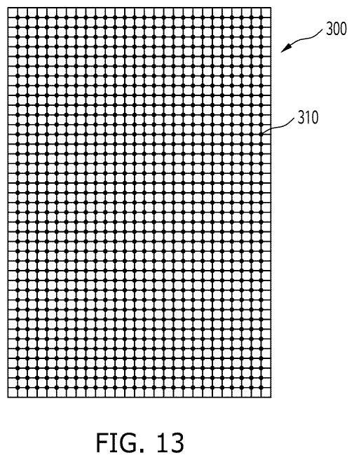

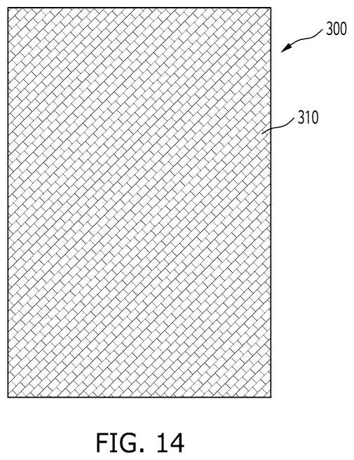

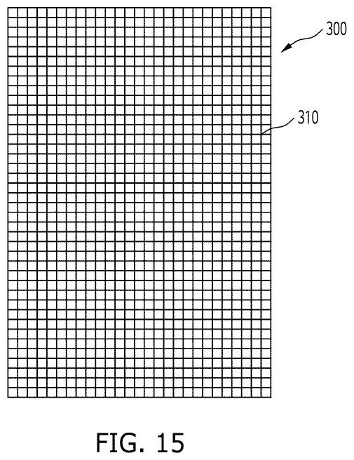

FIG. 13 is a view illustrating an example where a front shape of a notch groove forms a pattern/shape, FIG. 14 is a view illustrating another example where a front shape of a notch groove forms a pattern/shape, and FIG. 15 is a view illustrating yet another example where a front shape of a notch groove forms a pattern/shape.

The notch groove 310 shown in FIG. 13 to FIG. 15 may be the notch groove 310 formed in the cover 300. For example, the notch groove(s) 310 may form a shape patterned by repeating a square or a circle. Shapes other than a square or circle are likewise possible.

The notch groove 310 forming the pattern/shape may be present in the entire area or in only a partial area of the cover 300. The notch groove 310 forming the pattern/shape may provide a uniform adhesive force between the electrode assembly 100 and the cover 300 by forming an intricate pattern/shape. Accordingly, possible deformation due to the detachment/movement of the electrode assembly during a fall may be mitigated, and the risk of ignition accidents due to short circuits may be reduced, thereby improving the safety of the secondary battery.

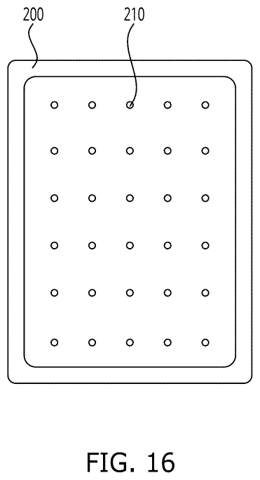

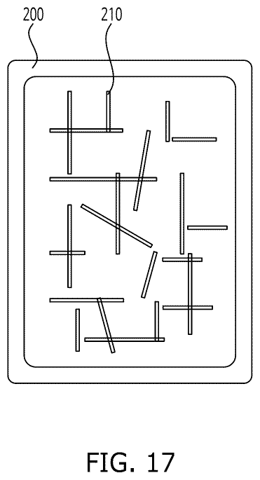

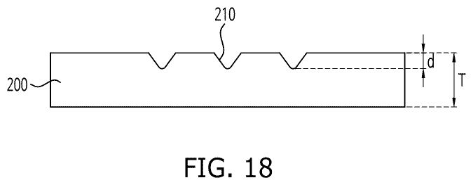

FIG. 16 is a view illustrating that a front shape of the notch groove is shaped in a multiple dots shape, FIG. 17 is a view illustrating an example where the front of the notch groove is formed by combining a plurality of lines, and FIG. 18 is a view illustrating the depth of the notch groove according to embodiments of the present disclosure.

Referring to FIG. 16, and FIG. 17, the front shape of the notch groove 210 may be a multiple-dots shape, multiple-curves shape, or multiple-straight lines shape. FIG. 16 illustrates that the notch groove 210 in the multiple-dots shape is in a regular pattern, though in other configurations the notch groove 210 may be formed in a random arrangement.

For example, the notch groove 210 may be placed in the inner surface of the case 20o in consideration of a movement direction and the weight/size/orientation/configuration of the electrode assembly. The shape and/or size of the notch groove 210 may be formed so that the notch groove 210 are less likely to be broken due to a physical impact or a smaller pressure.

Referring to FIG. 18, a depth d of the notch groove 210 may be between 5% and 10% (inclusive) of the thickness T of the case 200. When the depth d of the notch groove 210 is less than 5% of the thickness T of the case 200 the amount of the adhesive member inserted into the notch groove 210 may be small, such that the contact area may not be increased and the adhesive force between the electrode assembly 100 and the case 200 may not be increased. When the depth d of the notch groove 210 is formed by exceeding 10% of the thickness T of the case 200 the notch groove 210 may be broken due to the physical impact and the pressure, such that the rigidity of the case 200 itself may not be ensured, thus reducing a high-pressure stability.

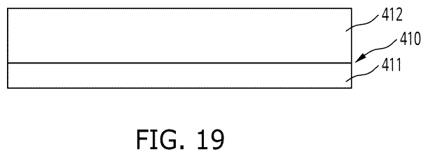

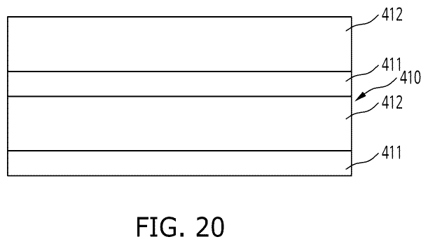

FIG. 19 is a view illustrating an example of a stacked structure of an adhesive member, and FIG. 20 is a view illustrating that an adhesive member is stacked in two layers.

The adhesive member 410 may include an adhesive layer 411 and a film layer 412. One side (i.e., a first surface) of the adhesive layer 411 may be adhered to the electrode assembly 100. The film layer 412 may be stacked on the other surface (i.e., a second surface) of the adhesive layer 411 while the film layer 412 is in contact with the notch groove.

The adhesive layer 411 may include at least one of hot melt, rubber, or acrylic. For example, when the adhesive layer 411 includes a hot melt adhesive, the hot melt adhesive may include an acrylic resin, a synthetic rubber resin, a polyolefin resin, an ester resin, a urethane resin, an epoxy resin, or a silicone resin, but it is not limited thereto. For example, the hot melt adhesive may be impregnated into the film by applying the melted hot melt adhesive solution onto the film layer 412 or by impregnating the film layer 412 with a hot melt adhesive solution dissolved in a solvent and then volatilizing the solvent. However, the present disclosure is not limited thereto, and various impregnation methods of the hot melt adhesive may be used.

The film layer 412 may include at least one of Oriented Polystyrene (OPS), Cast Polypropylene (CPP), Polyethylene terephthalate (PET), Polyethylene (PE), or High Impact Polystyrene (HIPS). The film layer 412 may be formed from an insulating material. The adhesive member 410 may be formed by stacking a plurality of layers. A plurality of adhesive members 410 may be placed on the inner surface of the case 200.

Therefore, the adhesive force between the electrode assembly 100 and the case 200 may be maintained, and the thickness of the adhesive member 410 between the electrode assembly 100 and the case 200 may be maintained. A uniform adhesive force between the electrode assembly 100 and the case 200 may be provided. Accordingly, the resistance against movement/detachment due to dropping may increase, thereby enhancing the safety of the secondary battery.

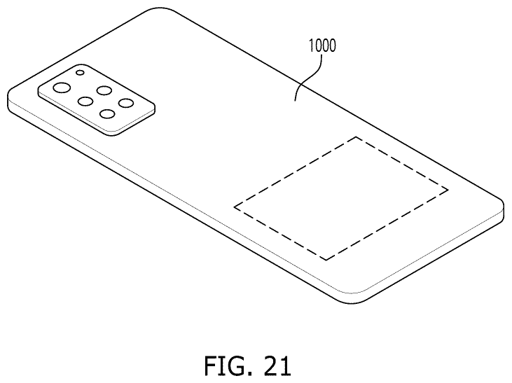

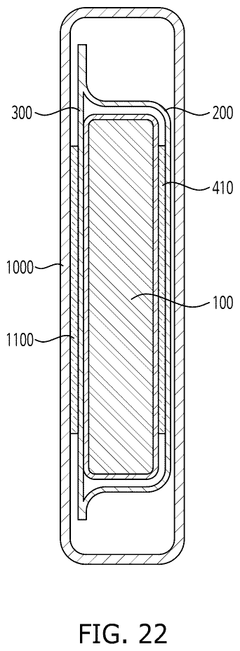

FIG. 21 is a schematic view illustrating a battery electronic device, and FIG. 22 illustrates that the secondary battery according to embodiments of the present disclosure is placed in the battery electronic device of FIG. 21.

Referring to FIG. 21 and FIG. 22, a battery electronic device 1000 may include a secondary battery fixed inside to provide power according to embodiments of the present disclosure.

The battery electronic device 1000 may be a smart phone, but it is not limited thereto, and may be used in various devices that use electric energy stored in a secondary battery and require a protection circuit. The secondary battery may be a lithium battery cell, a sodium battery cell, etc. However, the scope of the present disclosure is not limited thereto, and the secondary battery may include all types of batteries that repeatedly provide electricity by charging and discharging. According to embodiments, when the secondary battery is a lithium battery cell, the secondary battery may be used in an electric vehicle (EV) because of having an excellent life characteristic and a high-rate characteristic. For example, the secondary battery may be used in a hybrid vehicle such as a plug-in hybrid electric vehicle (PHEV). For example, the lithium battery cell may be used in fields that require a variety of ranges of power storages, for example, in smart phones, tablet PCs, electric bicycles, power tools, etc., but the present disclosure is not limited thereto.

The case 200 and the cover 300 may be fixed into the inside of the battery electronic device 1000 to stably provide power. Double-sided tape 1100 (e.g., an adhesive) may be provided between the cover 300 and the battery electronic device 1000 so that the case 200 and the cover 300 may be mounted in the battery electronic device 1000. The case 200 and the cover 300 may be mounted in the battery electronic device 1000 by the double-sided tape 1100.

The electrode assembly 100 may be adhered to the case 200 by the adhesive member 410. Therefore, the problem of detachment/movement of the electrode assembly 100 during impact caused by the dropping of the battery electronic device 1000 may be mitigated.

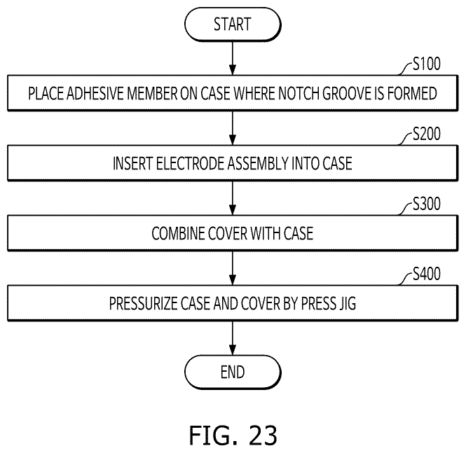

FIG. 23 is a flowchart illustrating an example of a manufacturing method of a secondary battery according to embodiments of the present disclosure.

The manufacturing method of the secondary battery may be initiated by performing arranging an adhesive member in a case where a notch groove is formed in step S100. Referring to FIG. 23, the manufacturing method of the secondary battery may include arranging an adhesive member in a case in step S100, inserting an electrode assembly in step S200, bonding a cover to the case in step S300, and pressurizing the combined case and the cover by a press jig in step S400 (the press jig removing any internal gas that occurs during initial charging and discharging processes).

The placing of the adhesive member in step S100 may be accomplished by placing an adhesive member in a case having a notch groove formed on an inner surface. The cross-sectional shape of the notch groove may be any one of a triangle, a square, a trapezoid, or an arc. The notch groove may include a plurality of linear notch grooves which extends in a first direction or a plurality of intersecting linear notch grooves extending in both the first direction and a second direction intersecting the first direction, and the plurality of linear notch grooves or the plurality of intersecting linear notch grooves may be separated from each other by a predetermined distance. The notch groove may be formed in a patterned shape with repeated squares or circles, and the front shape may be a multiple-dots shape, a multiple-curves shape, or a multiple-straight lines shape. According to embodiments, the depth of the notch groove may between 5% and 10% (inclusive) of the thickness of the case.

Before the step of inserting the electrode assembly in step S200, the step of arranging a compression member may be performed. The compression member may be placed between the electrode assembly and the cover, and the cover may include at least one notch groove formed on the inner surface where the compression member is arranged.

The step of inserting the electrode assembly in step S200 may include inserting the electrode assembly into an open surface of the case. The step of bonding the cover to the case in step S300 may include the bonding the cover to the open surface.

After the step of bonding the cover to the case in step S300, the step of pressurizing the case and the cover by a press jig may be performed in step S400. The assembled secondary battery may be cell-activated during the manufacturing process of the secondary battery, the press jig may pressurize the combined cover and the case, thus removing any internal gas that occurs during initial charging and discharging processes.

In the step of pressurizing the case and the cover by the press jig in step S400, an adhesive member may be pressurized between the electrode assembly and the case to be inserted into the notch groove. The adhesive member may be stacked on an adhesive layer or one surface of the adhesive layer adhered to the electrode assembly, and may include a film layer on a second surface of the adhesive layer, the film layer adhered to/contacting the notch groove.

In the step of pressurizing the case and the cover by the press jig in step S400, the adhesive member may be further compressed to the inner wall of the case, and that pressure may cause the adhesive member to be inserted into the notch groove. Therefore, the contact area between the adhesive member and the case may be maximized, and the adhesive force between the electrode assembly and the case may be increased, which improves the issue of detachment/movement of the electrode assembly 100 during a drop impact of the secondary battery 10.

The flow chart of FIG. 23 and the above description are merely exemplary, and the scope of the present disclosure is not limited to the flow chart of FIG. 23 and the above description. For example, one or more steps in the flow chart and the above description may be added/changed/deleted, the orders of one or more steps may be changed, and one or more steps may be performed simultaneously.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A secondary battery, comprising:
an electrode assembly comprising: a first electrode;
a separating film; and
a second electrode;
a case in which the electrode assembly is accommodated, the case including: an open surface, and an inner surface having at least one notch groove;
a cover coupled to the open surface of the case; and
at least one adhesive member interposed between the electrode assembly and the case,
wherein the adhesive member is placed in the at least one notch groove.

2. The secondary battery as claimed in claim 1, wherein the adhesive member is inserted into the at least one notch groove by being pressed between the electrode assembly and the case.

3. The secondary battery as claimed in claim 1, wherein a cross-sectional shape of the at least one notch groove is one of a triangle, a rectangle, a trapezoid, or an arc.

4. The secondary battery as claimed in claim 1, wherein the at least one notch groove comprises at least one of a plurality of linear notch grooves extending in a first direction or a plurality of intersecting linear notch grooves extending in both the first direction, and a second direction intersecting the first direction, and
wherein the plurality of linear notch grooves or the plurality of intersecting linear notch grooves are separated from each other by a predetermined distance.

5. The secondary battery as claimed in claim 1, wherein the at least one notch groove is formed in a patterned shape by repeating rectangles or circles.

6. The secondary battery as claimed in claim 1, wherein a shape of the at least one notch groove is a multi-dots shape, a multi-curves shape, or a multi-straight lines shape.

7. The secondary battery as claimed in claim 1, wherein a depth of the at least one notch groove is between 5% and 10% (inclusive) of a thickness of the case.

8. The secondary battery as claimed in claim 1, further comprising a compression member interposed between the electrode assembly and the cover,
wherein the cover comprises the at least one notch groove formed on the inner surface where the compression member is arranged.

9. The secondary battery as claimed in claim 1, wherein the adhesive member comprises,
an adhesive layer adhered to the electrode assembly via a first surface of the adhesive layer; and
a film layer on a second surface of the adhesive layer, the film layer contacting the at least one notch groove.

10. The secondary battery as claimed in claim 9, wherein the adhesive layer comprises at least one of hot melt, rubber, or acrylic, and
wherein the film layer comprises at least one of oriented polystyrene (OPS), cast polypropylene (CPP), polyethylene terephthalate (PET), polyethylene (PE), or high impact polystyrene (HIPS).

11. The secondary battery as claimed in claim 1, wherein one of the case or the cover includes stainless steel (SUS).

12. A method for manufacturing a secondary battery, the method comprising:
arranging an adhesive member in a case, where a notch groove is formed in an inner surface of the case;
inserting an electrode assembly through an open surface of the case and into the case;
bonding a cover onto the open surface of the case; and
combining the case and the cover together by a press jig.

13. The method as claimed in claim 12, wherein the adhesive member is pressed between the electrode assembly and the case such that the adhesive member is inserted into the notch groove.

14. The method as claimed in claim 12, wherein a cross-sectional shape of the notch groove is one of a triangle, a rectangle, a trapezoid, or an arc.

15. The method as claimed in claim 12, wherein the notch groove comprises a plurality of linear notch grooves extending in a first direction or a plurality of intersecting linear notch grooves extending in both the first direction and a second direction intersecting the first direction, and
wherein the plurality of linear notch grooves or the plurality of intersecting linear notch grooves are separated from each other by a predetermined distance.

16. The method as claimed in claim 12, wherein the notch groove is formed in a patterned shape by repeating a rectangle or a circle.

17. The method as claimed in claim 12, wherein a shape of the notch groove is a multiple-dots shape, a multiple-curves shape, or a multiple-straight lines shape.

18. The method as claimed in claim 12, wherein a depth of the notch groove is between 5% and 10% (inclusive) of a thickness of the case.

19. The method as claimed in claim 12, further comprising inserting a compression member between the electrode assembly and the cover,
wherein the cover comprises the notch groove formed on the inner surface where the compression member is arranged.

20. The method as claimed in claim 12, wherein the adhesive member comprises,
an adhesive layer adhered to the electrode assembly via a first surface of the adhesive layer; and
a film layer on a second surface of the adhesive layer, the film layer contacting the notch groove.
